(19) United States
(12) Patent Application Publication
(10) Pub. No.: US 2026/0221800 A1
(43) Pub. Date: Jul. 30, 2026

(54) UNINTERRUPTIBLE POWER SUPPLY WITH AN AUTONOMOUS UNDER FREQUENCY DETECTION AND LOAD SHEDDING FUNCTIONALITY

(71) Applicant: EATON INTELLIGENT POWER LIMITED, Dublin 4 (IE)

(72) Inventors: Jenne Mikael PAANANEN, Länsi-Suomi (FI); Teemu Juhani PAAKKUNAINEN, Lohja Uusimaa (FI)

(21) Appl. No.: 19/145,306

(22) PCT Filed: Dec. 29, 2023
(86) PCT No.: PCT/EP2023/025560

§ 371 Date: Jul. 2, 2025

(30) Foreign Application Priority Data
Jan. 30, 2023 (GB) 2301299.0

(51) Int. Cl. H02J 9/06

(52) U.S. Cl. CPC H02J 9/062

(57) ABSTRACT

Some embodiments relate to an uninterruptible power supply (UPS) which includes an Alternating Current (AC) mains supply input for connecting the UPS to an AC mains supply; an AC power supply output for supplying at least one load connected to the AC power supply output with electric power; a Direct Current (DC) link; a rectifier for converting AC received via the AC mains supply input into a DC and supplying it to the DC-link; an inverter for converting DC received from the DC-link into an AC for supplying it via the AC power supply output; a storage for electrical energy being connected to the DC-link via a controllable DC/DC converter; a frequency measurement unit provided for measuring the frequency of the AC supplied via the AC mains supply input; and a controller configured for detecting an under-frequency condition of the AC supplied via the AC mains supply input.

### CROSS-REFERENCE TO RELATED APPLICATIONS

This application is a national phase filing under 35 C.F.R. § 371 of and claims priority to PCT Patent Application No. PCT/EP2023/025560, filed on Dec. 29, 2023, which claims the benefit of British Application No. 2301299.0, filed on Jan. 30, 2023, the contents of which are hereby incorporated in their entireties by reference.

### TECHNICAL FIELD

This specification relates to an uninterruptible power supply (UPS) with an autonomous under frequency detection and load shedding functionality.

### BACKGROUND

The international patent application WO2022/233457A1 discloses a system for frequency regulation in an Alternating Current (AC) power supply system. The system comprises an UPS being electrically connected to the AC power supply system and comprising a phase-locked loop and/or a frequency-locked loop for monitoring the frequency of an AC input voltage received from the AC power supply system, wherein the phase-locked loop (PLL) and/or the frequency-locked loop (FLL) is/are designed to be operated with an operation frequency being higher than a nominal grid frequency and being selected to detect a deviation of the monitored frequency from the nominal grid frequency within a predefined time span after a frequency drop off of the monitored frequency occurred. A control signal is generated based on the detected deviation of the monitored frequency from the nominal grid frequency. The generated control signal is used to regulate the power flow between the uninterruptible power supply and the grid until the monitored frequency is within a predefined range around the nominal grid frequency. This system provides support to the AC power supply system, for example a low-inertia generator-fed power supply system, by enabling a control system of the UPS to react to frequency deviations from the nominal grid frequency. The system particularly utilizes a fast, sub-cycle frequency measurement from the PLL or FLL provided by an internal measurement system in an UPS to implement the frequency regulation. By using the PLL or FLL, a fast frequency measurement may be provided, which makes it possible to monitor the frequency of the AC input voltage even in an initial frequency drop-off, and, thus, allows the UPS to almost immediately react to detected frequency deviations.

### SUMMARY

This specification describes an UPS with an autonomous under frequency detection and load shedding functionality.

According to an aspect of this specification, an UPS comprises the following: an AC mains supply input for connecting the UPS to an AC mains supply; an AC power supply output for supplying at least one load connected to the AC power supply output with electric power; a Direct Current—DC—link; a rectifier for converting AC received via the AC mains supply input into a DC and supplying it to the DC-link; an inverter for converting DC received from the DC-link into an AC for supplying it via the AC power supply output; at least one storage for electrical energy being connected to the DC-link via a controllable DC/DC converter; a frequency measurement unit provided for measuring the frequency of the AC supplied via the AC mains supply input; and a controller configured for detecting an under-frequency condition of the AC supplied via the AC mains supply input and for regulating the electric power demand via the AC mains supply input by controlling the supply of the at least one load connected to the AC power supply output with electric power from the at least one storage for electrical energy and/or from the AC main supply input as a function of the detected under-frequency condition.

In an embodiment, the regulating of the electric power demand via the AC mains supply input may comprise controlling the DC/DC converter to control the power flow from the at least one storage for electrical energy to the at least one load connected to the AC power supply output.

In embodiments, the detecting of an under-frequency condition of the AC supplied via the AC mains supply input comprises detecting a frequency anomaly of the measured frequency, wherein the frequency anomaly comprises the falling of the measured frequency below one or more predefined frequency limits.

In further embodiments, the UPS may comprise an output power measurement unit provided for measuring the output power supplied to the at least one load, wherein the regulating of the electric power demand via the AC mains supply input further comprises the controlling of the supply of the at least one load connected to the AC power supply output with electric power from the at least one storage and/or the AC main supply input as a function of the detected frequency anomaly and the measured output power.

In yet further embodiments, the controlling of the supply of the at least one load connected to the AC power supply output with electric power from the at least one storage and/or the AC main supply input as a function of the detected under-frequency condition may comprise allocating the supply with electric power from the at least one storage for protecting critical load among the at least one load connected to the AC power supply output.

In an embodiment, the allocating of the supply with electric power from the at least one storage for protecting critical load among the at least one load connected to the AC power supply output may be based on defined parameter settings, which determine a limit of discharging the at least one storage.

In embodiments, the controller may be further configured for shedding one or more of the at least one load connected to the AC power supply output depending on the detected under-frequency condition and/or the entire load connected to the AC power supply output.

In further embodiments, the controller may be configured for regulating the electric power demand via the AC mains supply input by shedding one or more of the at least one load connected to the AC power supply output if the detected under-frequency condition exceeds one or more predefined thresholds, wherein the one or more predefined thresholds comprises one or more of the following: maximum duration of the under-frequency condition; maximum deviation of the detected under-frequency condition from a required frequency; maximum rate of change of the detected under-frequency condition.

According to a further aspect of this specification, a redundant power distribution topology comprises several power distribution paths for supplying one or more loads, wherein each load is supplied with electric power from at least two power distribution paths, wherein each power distribution path comprises an UPS with an autonomous under frequency detection functionality of any of the preceding claims.

The details of one or more embodiments are set forth in the accompanying drawings and the description below. Other features and advantages will be apparent from the description and drawings, and from the claims.

### DESCRIPTION OF DRAWINGS

FIG. 1 shows a block diagram of an embodiment of an UPS with an autonomous under frequency detection and load shedding functionality;

FIG. 2 shows an example of a redundant power distribution topology comprising traditional UPSs and UFLS relays; and

FIG. 3 shows an embodiment of a redundant power distribution topology comprising UPSs with an autonomous under frequency detection functionality and load shedding for the AC mains supply by reducing its own AC mains input demand.

### DETAILED DESCRIPTION

In the following, functionally similar or identical elements may have the same reference numerals. Absolute values are shown below by way of example only and should not be construed as limiting.

Under frequency load shedding (UFLS) is a commonly used practice by operators of an electric transmission system (grid) as a final effort to restore power balance in the system following a large contingency event and after primary methods (frequency regulation) has failed to contain the grid frequency within specified limits. Within European Union countries, UFLS is mandated by Commission regulation EU 2017/2196 of 24 Nov. 2017 establishing a network code on electricity emergency and restoration.

In practice if the grid frequency drops to a specified level, limits given in the regulation for European synchronous areas, the system operators are obligated to disconnect consumption (demand) from the grid. This demand may be composed by large energy consumers connected directly to a high voltage (HV) grid and medium voltage (MV) distribution networks. The demand disconnection is done by using UFLS relays, and it may cause (wide) power outages in the system.

For a large energy consumer connected to the HV grid, such as a data center, disconnecting the power completely and causing a power outage can cause severe operational risks. Often in these installations one would have one or more back-up generators starting and supplying loads, but not necessarily if these are not needed for normal situations. And the situations requiring an UFLS activation can be extremely rare, for example it has never happened in Nordics, and therefore providing back-up generators only for that instance increases technical complexity. Nevertheless, it is a technical requirement to get permission to connect to an HV network, and the likelihood for an UFLS event may grow due to energy transition and introduction of more and more non-synchronous power generation sources such as wind and solar energy sources into the grid.

The herein described leveraging of an UPS for an UFLS function allows an asset owner to comply with required demand reduction without causing a power outage by moving some of the demand to the UPS energy storage, for example the batteries. As the required demand reduction may not be 100%, only part of the loads (demand) can be moved to the UPS energy storage until the frequency at the AC mains supply input of the UPS is recovered. Compared to the traditional approach by a tripping main feeder in a HV connection and moving 100% of the loads on batteries and operating a whole site in battery mode, the herein proposed technical solution may be more secure for a mission critical operation and may allow to severely reduce the operational risks as partially discharging batteries may allow much longer operation in that mode. Also, after tripping a main HV connection, the connection may not be able to be restored after the AC mains supply frequency has recovered before the batteries are fully discharged and critical load shuts down. So, in simplified terms, the herein described technical solution can provide UFLS without the need to shut down (critical) loads in systems that do not have back-up power generation.

As an UFLS feature may be a requirement for connection to a HV grid, it may have to be operational whenever a site (demand/loads) is connected to the HV grid. Therefore, having an UFLS functionality integrated into an UPS as the herein described solution provides it, whenever the UPS is operational, is the preferred method to do it. Relying on external devices to control the UPS UFLS response is subject to communication/signal failures etc. Also, the UFLS response is preferred to be proportional to an actual UPS load. As the demand varies, the response varies. This is especially beneficial on systems with in-built redundancy, such as data centres. When one part of the system is under maintenance, and loads are supported by other parts of the system (site), the equipment supporting the load adapts the response (increases it) as their load increases, and vice versa, and system (site) provides the correct amount of UFLS response when needed (“response follows the load”).

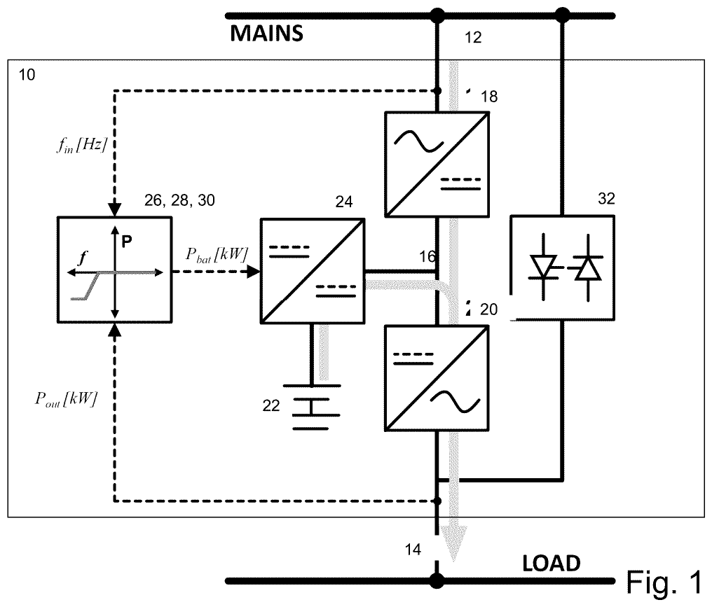

FIG. 1 shows a block diagram of an embodiment of an UPS 10 having an AC mains supply input 12 for connecting the UPS 10 to an AC mains supply (MAINS in FIG. 1).

The UPS 10 further comprises an AC power supply output 14 for supplying at least one load (LOAD in FIG. 1) connected to the AC power supply output 14 with electric power. The AC power supply output 14 may comprise one or more outlets to connect one or more loads, for example one or more information technology (IT) devices such as computers in a datacentre and supplying them via the UPS 10 with electric energy.

The AC mains supply input 12 is connected to the AC power supply output 14 via a Direct Current-DC-link 16: a rectifier 18 converts AC received via the AC mains supply input 12 into a DC and supplies it to the DC-link 16; an inverter 20 converts DC received from the DC-link 16 into an AC for supplying it via the AC power supply output 14; at least one storage 22 for electrical energy, particularly one or more (rechargeable) batteries is connected to the DC-link 16 via a controllable DC/DC converter 24. The AC mains supply input 12 can be directly connected to the AC power supply output 14 via a bypass switch 32, particularly during normal operation of the UPS 10, for example when no power outage occurs and/or no anomalies occur at the AC main supply input 12.

The UPS 10 comprises a frequency measurement unit 26, which is provided for measuring the frequency of the AC supplied via the AC mains supply input 12, and a controller 28, which is configured for detecting an under-frequency condition of the AC supplied via the AC mains supply input 12 and for regulating the electric power demand via the AC mains supply input 12 by controlling the supply of the load(s) connected to the AC power supply output 14 with electric power from the storage(s) 22 for electrical energy and/or from the AC main supply input 12 as a function of the detected under-frequency condition.

The regulating of the electric power demand via the AC mains supply input 12 may comprise controlling the DC/DC converter 24 to control the power flow from the storage(s) 22 to the load(s) connected to the AC power supply output 14, thus allowing to control the electric power demand from the AC mains supply input 12 and the storage(s) 22. The power flow within the UPS 10 from the AC mains supply input 12 and the storage(s) 22 to the Ac power supply output 14 is shown in FIG. 1 by the thick arrow.

The controller 28 may be for example implemented by a processor configured with a program stored in a non-volatile memory to perform the assigned tasks, or as an Application Specific Integrated Circuit (ASIC) or as a (Field) Programable Gate Array ((F)PGA).

The controller 28 implements an algorithm, which processes the frequency of the AC supplied via the AC mains input 12 and measured by the frequency measurement unit 26. The processing comprises the detecting of an under-frequency condition of the AC supplied via the AC mains supply input 12. Particularly, this comprises detecting a frequency anomaly of the measured frequency. The frequency anomaly may for example comprise the falling of the measured frequency below one or more predefined frequency limits, for example one or more of 48.8 Hertz (Hz), 48.6 Hz, 48.4 Hz, 48.2 Hz, 48.0 Hz in a AC mains supply with a nominal frequency of 50 Hz.

The UPS 10 may also comprise an output power measurement unit 30, which is provided for measuring the output power supplied to the load(s). The measured output power can then together with the detected frequency anomaly used as parameters of a function for controlling of the supply of the load(s) connected to the AC power supply output 14 with electric power from the storage(s) 22 and/or the AC main supply input 12 for regulating of the electric power demand via the AC mains supply input 12.

The controlling of the supply of the load(s) connected to the AC power supply output 14 with electric power from the storage(s) 22 and/or the AC main supply input 12 as a function of the detected under-frequency condition may comprise allocating the supply with electric power from the storage(s) 22 for protecting critical load among the at least one load connected to the AC power supply output 14. For example, when the detected under-frequency condition predicts possible damages of critical loads, for example loads with a certain requirement of the AC power supply frequency, the controller 28 may control the supply of critical loads such that these loads are supplied only with electric power from the storage(s) with the required AC power supply frequency. This can be for example implemented in that the controller 28 switches the outlets of the AC power supply output 14, to which the critical loads are connected to a supply from the storage(s) 22. The allocating may be based on defined parameter settings such as the determining of a limit of discharging the storage(s). For example, a parameter setting of a maximum discharging current in Ampere from the storage(s) or a maximum duration of a discharging with a certain discharging current such as 10 Ampere for 5 minutes may be defined. Several limits of discharging may be defined, particularly different combinations of discharging current and discharging time. The defined parameter settings may particularly protect the storage(s) from overload and damages through high discharging currents.

The controller 28 may be further configured for shedding one or more of the load(s) connected to the AC power supply output 14 depending on the detected frequency under-frequency condition and/or for shedding the entire load connected to the AC power supply output 14. The shedding can be implemented by switching off one or more outlets of the AC power supply output 14, to which loads are connected. For example, the controller 28 may switch off all outlets, to which heavy loads such as electric motors are connected, or it may switch off all outlets, to which loads are connected, which are highly sensitive to under frequency conditions such as IT devices.

The controller 28 may particularly be configured for regulating the electric power demand via the AC mains supply input 12 by shedding one or more load(s) connected to the AC power supply output 14 if the detected under-frequency condition exceeds one or more predefined thresholds, which particularly comprise one or more of the following: maximum duration of the under-frequency condition; maximum deviation of the detected under-frequency condition from a required frequency; maximum rate of change of the detected under-frequency condition. For example, only when the duration of the detected under-frequency condition exceeds a predefined (maximum) duration and/or only when the deviation (time and/or frequency) of the detected under-frequency condition exceeds a predefined maximum from the required frequency, the controller 28 may shed one or more load(s). The maximum rate of change may for example determine that fast frequency changes may result in load shedding, whereas slow frequency changes, i.e. frequency change below the maximum rate of change, do not result in load shedding. Several predefined thresholds may be combined depending on the requirements.

The herein described regulating of the electric power demand via the AC mains supply input 12 by controlling the supply of the at least one load connected to the AC power supply output 14 with electric power from the at least one storage 22 for electrical energy and/or from the AC main supply input 12 as a function of the detected under-frequency condition may be based on defined droop curves, and particularly a linear ramp or discrete steps may be used to derive the power supply response from storage(s) and to regulate the storage(s) discharge to provide the “correct” amount of power from storage(s) for demand connected to an UPS.

Next, the application of the herein described UPS with an autonomous under frequency detection functionality in redundant power distribution topologies is described by examples.

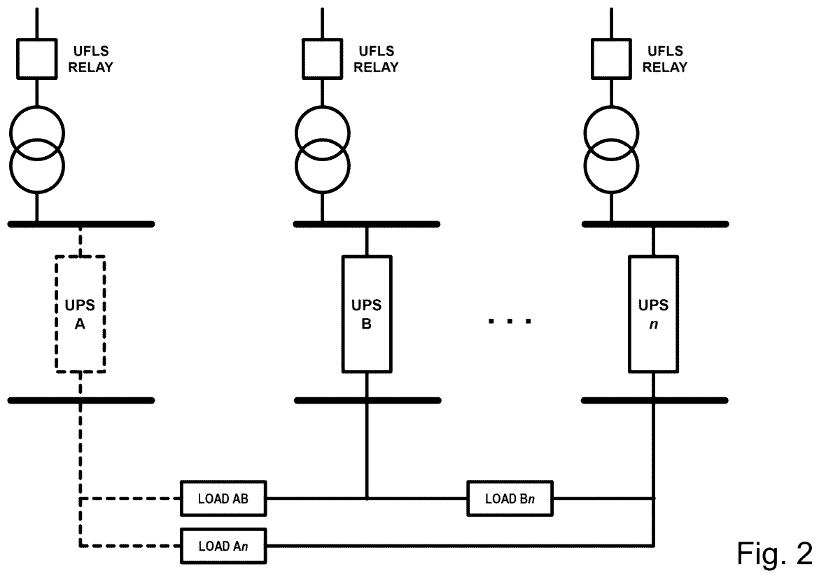

FIG. 2 shows a redundant power distribution topology comprising traditional UPSs UPS A to n and UFLS relays. Several loads AB to An and Bn are connected to AC power supply outputs of one or more of the UPSs. Each of the loads is redundantly supplied by two UPSs: load AB is supplied bx UPS A and B, load An by UPS A and n, load Bn by UPS B and n. Thus, for critical loads at least two active power distribution paths are provided, and each load is shared between these paths. When one of the UPSs would have a fault resulting in a power outage on its AC power supply output(s) or taken into service, for example UPS A (shown in dotted lines), the demand on this path, i.e. the power distribution path via the faulty or serviced UPS A, would be automatically moved to other healthy paths, in FIG. 2 via the UPS B and UPS n (shown with solid lines). The UPSs A to n are connected with their AC mains supply inputs to the grid via UFLS relays. When an under-frequency condition is detected, the traditional UFLS method is used by using the UFLS relays to disconnect demand by opening circuit breakers in individual paths to create discrete steps so that the demand from that path may be transferred to other paths once the energy storage of the UPS in the disconnected path is depleted, or immediately by automated load management. As a result, a demand reduction for the grid to provide UFLS can be net-zero. Furthermore, would one redundant power distribution path be under service, its demand would be zero and tripping the UFLS relay and circuit breaker would not result in any demand reduction.

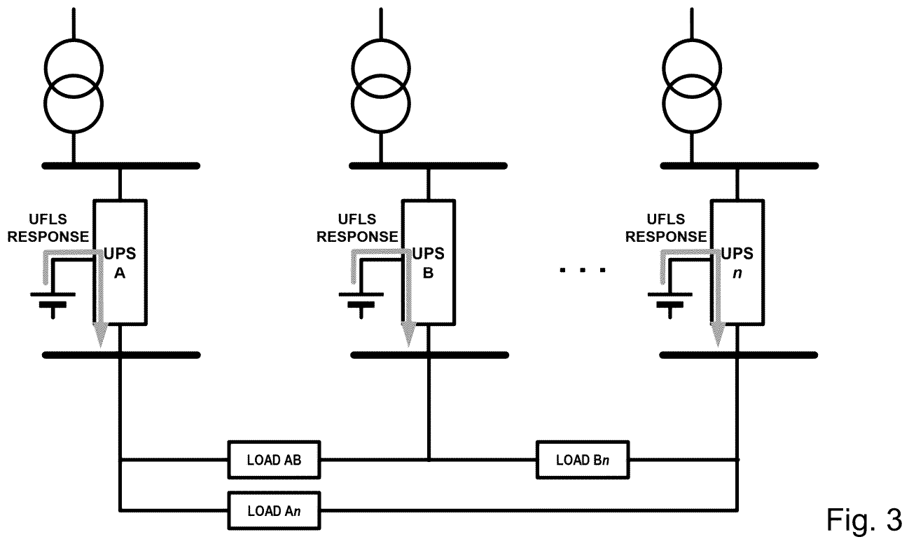

FIG. 3 shows an embodiment of the redundant power distribution topology of FIG. 2 applying UPSs A to n with each UPS comprising an autonomous under frequency detection functionality as described herein. In contrast to the topology shown in FIG. 2, the application of UPSs as described herein to provide an UFLS response proportional to an actual load, by moving the demand to an energy storage of UPS by a linear ramp or discrete steps, may ensure that the required UFLS response can be provided to support the grid under most critical contingency events under various operating conditions of a mission critical facility. Due to the implementation of the autonomous under frequency detection functionality in the UPS as described herein, the topology of FIG. 3 also does not require separate UFLS relays as the topology from FIG. 2.

### REFERENCE NUMERALS AND ABBREVIATIONS

10 UPS
12 AC mains supply input
14 AC power supply output
16 DC-link
18 Rectifier
20 Inverter
22 energy storage (e.g., one or more batteries)
24 DC/DC converter
26 frequency measurement unit
28 controller
30 output power measurement unit
32 bypass switch
AC Alternating Current
DC Direct Current
FLL Frequency-locked loop
HV High voltage
IT Information technology
MV Medium voltage
PLL Phase-locked loop
UFLS Under frequency load shedding
UPS Uninterruptible power supply

1. An uninterruptible power supply—UPS—comprising:
an Alternating Current—AC—mains supply input for connecting the UPS to an AC mains supply;
an AC power supply output for supplying at least one load connected to the AC power supply output with electric power;
a Direct Current—DC—link;
a rectifier for converting AC received via the AC mains supply input into a DC and supplying it to the DC-link;
an inverter for converting DC received from the DC-link into an AC for supplying it via the AC power supply output;
at least one storage for electrical energy being connected to the DC-link via a controllable DC/DC converter;
a frequency measurement unit provided for measuring the frequency of the AC supplied via the AC mains supply input;
an output power measurement unit provided for measuring the output power supplied to the at least one load; and
a controller configured for detecting an under-frequency condition of the AC supplied via the AC mains supply input and for regulating the electric power demand via the AC mains supply input by controlling the supply of the at least one load connected to the AC power supply output with electric power from the at least one storage for electrical energy and from the AC main supply input as a function of the detected under-frequency condition and the measured output power.

2. The UPS of claim 1, wherein the regulating of the electric power demand via the AC mains supply input comprises controlling the DC/DC converter to control the power flow from the at least one storage for electrical energy to the at least one load connected to the AC power supply output.

3. The UPS of claim 1, wherein the detecting of an under-frequency condition of the AC supplied via the AC mains supply input comprises detecting a frequency anomaly of the measured frequency, wherein the frequency anomaly comprises the falling of the measured frequency below one or more predefined frequency limits.

4. The UPS claim 1, wherein the controlling of the supply of the at least one load connected to the AC power supply output with electric power from the at least one storage and/or the AC main supply input as a function of the detected under-frequency condition comprises allocating the supply with electric power from the at least one storage for protecting critical load among the at least one load connected to the AC power supply output.

5. The UPS of claim 4, wherein the allocating of the supply with electric power from the at least one storage for protecting critical load among the at least one load connected to the AC power supply output is based on defined parameter settings, which determine a limit of discharging the at least one storage.

6. The UPS of claim 1, wherein the controller is further configured for shedding one or more of the at least one load connected to the AC power supply output depending on the detected frequency under-frequency condition and/or the entire load connected to the AC power supply output.

7. The UPS of claim 1, wherein the controller is configured for regulating the electric power demand via the AC mains supply input by shedding one or more of the at least one load connected to the AC power supply output if the detected under-frequency condition exceeds one or more predefined thresholds, wherein the one or more predefined thresholds comprises one or more of the following: maximum duration of the under-frequency condition; maximum deviation of the detected under-frequency condition from a required frequency; maximum rate of change of the detected under-frequency condition.

8. A redundant power distribution topology comprising several power distribution paths for supplying one or more loads, wherein each load is supplied with electric power from at least two power distribution paths, wherein each power distribution path comprises an UPS with an autonomous under frequency detection functionality of claim 1.
